(19) United States
(12) Patent Application Publication
(10) Pub. No.: US 2007/0158458 A1
(43) Pub. Date: Jul. 12, 2007

(54) Sprinkling unit suitable for serial placement

(76) Inventor: Wayne K. Wheeler, Noblesville, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/316,221

(22) Filed: Dec. 22, 2005

(51) Int. Cl. A01G 27/00

(52) U.S. Cl. 239/69; 239/551; 239/276; 239/273; 239/536; 137/624.18; 137/625; 137/883

(57) ABSTRACT

A readily expandable portable above ground sprinkling system for watering a newly sodded lawn is provided. The system includes a portable container housing a water inlet, a bypass outlet, a battery powered control means, and a plurality of hose outlets, each having an associated flow control valve. A plurality of sprinkler heads are connected in fluid communication to the hose outlets with standard hoses. The control means is operable to electronically regulate the valves in order to accomplish a desired watering pattern.

### FIELD OF THE INVENTION

This present invention relates generally to lawn sprinkling systems. In particular, the invention pertains to a sprinkling unit suitable for serial placement.

### BACKGROUND OF THE INVENTION

Sprinkler systems used for lawn and garden watering are well-known in the art. In order to establish or maintain a healthy lawn, yard, or garden, a sufficient amount of water must be properly distributed. The existing watering systems in the art typically fall into two major categories, above ground and underground systems.

Underground systems generally include buried water supply lines and a plurality of permanently installed sprinkler heads. These sprinkler heads are often retractable so as to avoid damage or inconvenience. These underground systems utilize timers and control systems of varying complexity in order to accomplish various watering schemes. For example, U.S. Pat. No. 4,265,403, discloses a system having a plurality of sprinkler heads mounted in series and connected to a common water supply for operation by a control timer. While these underground systems do provide an effective means of watering, they also have several disadvantages. Underground systems are expensive to install and repair. Often, in cold climates, these repairs are frequent due to freezing and cracking of the water lines. The permanent nature of these systems also discourages modification of the subject lawn or garden without extensive costs.

Above ground watering systems and devices do not suffer from these problems. The simplest above ground system involves a water hose connected between a sprinkler head and a water outlet and positioned in a particular location. The most prominent disadvantage to the above ground system is the burden put upon the user to lay out the system, re-position the sprinkler head, and cycle the system between on and off as needed.

A subclass of above ground systems includes portable watering systems, which exist to address several disadvantages of other systems in the class. These systems are often designed to facilitate the establishment of a new lawn or garden. These portable systems are especially beneficial to contractors who provide lawn establishment and landscaping services to new home constructions and commercial buildings. One difficulty in using these systems is that a contractor frequently sees numerous different jobs of vastly different sizes and varying circumstances. For instance, one job may entail a lawn of 3 acres while another may only be ¼ acre; one lawn may be in an established neighborhood while another may be for a model home currently lacking power. Existing portable systems in the art fail to provide a system which is inexpensive, readily expandable, and self-contained. Therefore, there exists a need for an inexpensive portable watering system that can automatically deliver the water necessary to aide in the establishment of a new lawn or garden of any size under any circumstances.

### SUMMARY OF THE INVENTION

Accordingly, it is an object of this invention to provide a sprinkling unit suitable for serial placement in watering a lawn or garden.

Another object of this invention is to provide an expandable above ground watering system having a compact design for easy storage and portability.

Still another object of this invention is to provide an expandable above ground watering system capable of automatic unattended watering of a lawn or garden.

Yet another object of this invention is to provide an expandable above ground watering system that requires only one water supply.

Yet another object of this invention is to provide an expandable above ground watering system with a battery operated control means.

### BRIEF DESCRIPTION OF THE DRAWINGS

FIG. 1 is a perspective view of the sprinkling system showing the system in a disassembled state.

FIG. 2 is a perspective view of a preferred embodiment of the sprinkling unit with several controlled outlets.

FIG. 3 is an alternate perspective view of a preferred embodiment of the sprinkling unit with a water supply inlet and supply bypass outlet.

FIG. 4 is a detailed overhead view of the sprinkling unit.

FIG. 5 is an overhead view of several sprinkling units serially connected to achieve watering of a large lawn.

FIG. 6 is a detailed overhead view of the three sprinkling units in FIG. 5 showing their connections.

### DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

Modern construction techniques have greatly decreased the amount of time necessary to construct a new home or commercial building. However, a new home or place of business isn't truly complete until all of the finishing touches have been completed. The most prominent of these is the landscaping including the establishment of a new lawn. Numerous methods exist for establishing a new lawn, each with their own advantages. These methods include traditional seeding, sodding, or hydroseeding. However, regardless of which establishment method used, the key ingredient to success is the ability to keep the soil moist for three to four weeks.

Landscaping is commonly established around a new home or commercial construction before the homeowners or tenants move in. However, some homeowners opt to replace the existing landscaping or lawn to achieve a more desirable look. Thus, the responsibility to ensure that the new lawn or landscaping receives adequate water must fall upon either the contractor or the homeowner. Since most homeowners typically work and have other responsibilities that require their time, there is a need for a readily expandable portable sprinkling system that may be arranged and programmed by the contractor to ensure that sufficient watering will occur during this critical period, thereby allowing the contractor to pursue other jobs and the homeowner to go about their life uninterrupted.

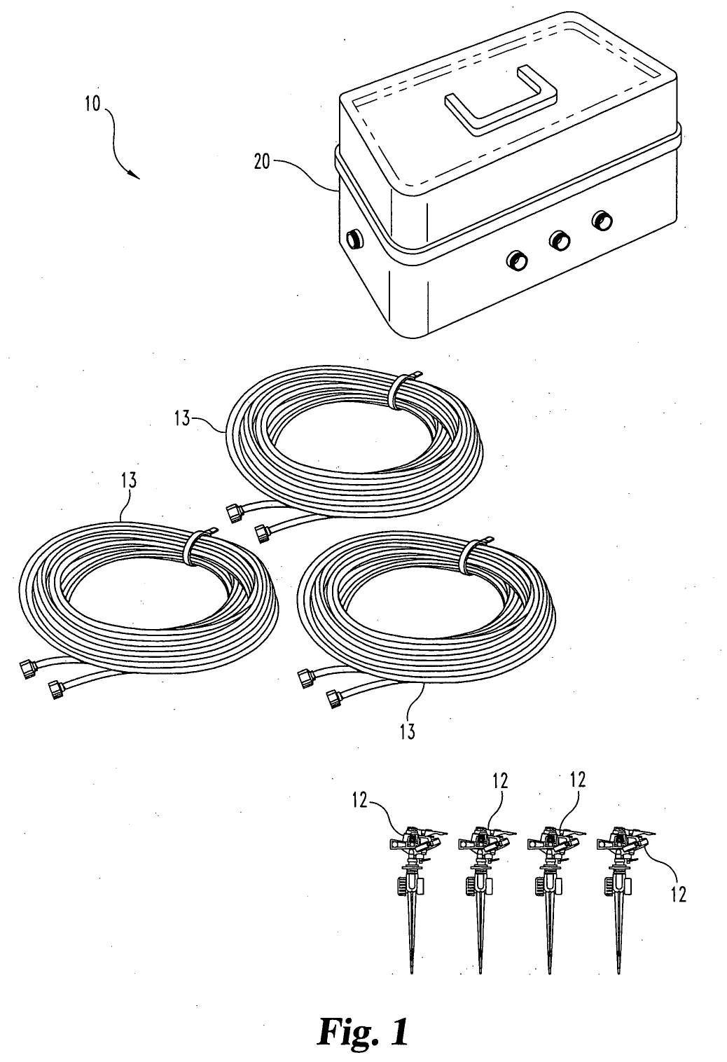

Referring now to the drawings, FIG. 1 illustrates a portable expandable above ground sprinkler system 10. The system 10 includes one or more sprinkling units suitable for serial placement 20, one or more sprinkler heads 12, and several standard garden hoses 13. The system 10 is shown in a disassembled state suitable for transportation and compact storage by placing sprinkler heads 12 within unit 20.

In system 10 a plurality of watering devices or sprinkler heads 12 are provided. Any number of watering devices or sprinkler heads 12 may be used by this system. For example, oscillating or rotating sprinklers, impact sprinkler heads, and soaker or drip hoses are all suitable for use in the system. Preferably, sprinkler head 12 is an impact sprinkler head having an elongated spike for removable placement into the ground. The sprinkler head 12 is preferably adjustable for varying the distances of the water, the angle covered by the spray, and the quantity of water delivered. Additionally, sprinkler head 12 preferably has a pass through valve with a terminating cap making each sprinkler head 12 suitable for serial placement. In the illustrative embodiment, the spike sprinkler manufactured by Orbit Irrigation Products, Inc. of North Salt Lake, Model No. 58169 has proven satisfactory for sprinkler head 12.

Several standard garden hoses 13 are provided with system 10 and preferred for proper set-up and use. A standard garden hose 13 has a standard threaded male hose connector at one end and a standard threaded female hose connector at the other end. Any standard garden hose of varying length is satisfactory for use in the system 10 depending upon the characteristics of the area to be watered and the proximity of the water source. In order to expand the system the user may utilize any standard garden hose that may be found in most garages or on the shelves of a local hardware store or retailer.

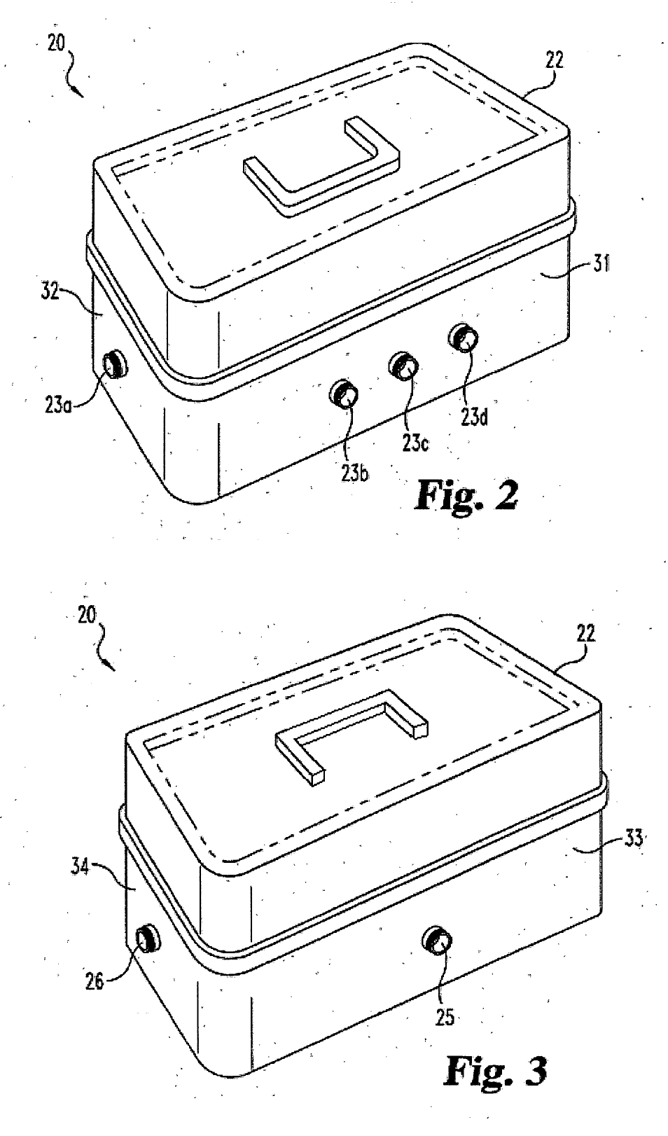

As shown in FIGS. 2-4 the sprinkling unit 20 is comprised of a manifold 21 mounted within a portable container 22, a backflow preventer valve 30, four controlled outlets 23a, 23b, 23c, and 23d each having an associated flow control valve 24a, 24b, 24c, and 24d respectively, a water supply inlet 25, and a water supply bypass outlet 26.

Referring to FIGS. 2-3, controlled outlets 23, water supply inlet 25, and water supply bypass outlet 26 extend through the various sides of portable container 22. More specifically, portable container 22 includes a front face 31, side faces 32 and 34, and a rear face 33. In the example shown, water supply inlet 25 is mounted centrally in the rear face 33, water supply bypass 26 is mounted to side face 34, controlled outlet 23a is mounted to side face 32, and controlled outlets 23b, 23c, and 23d are linearly mounted to front face 31.

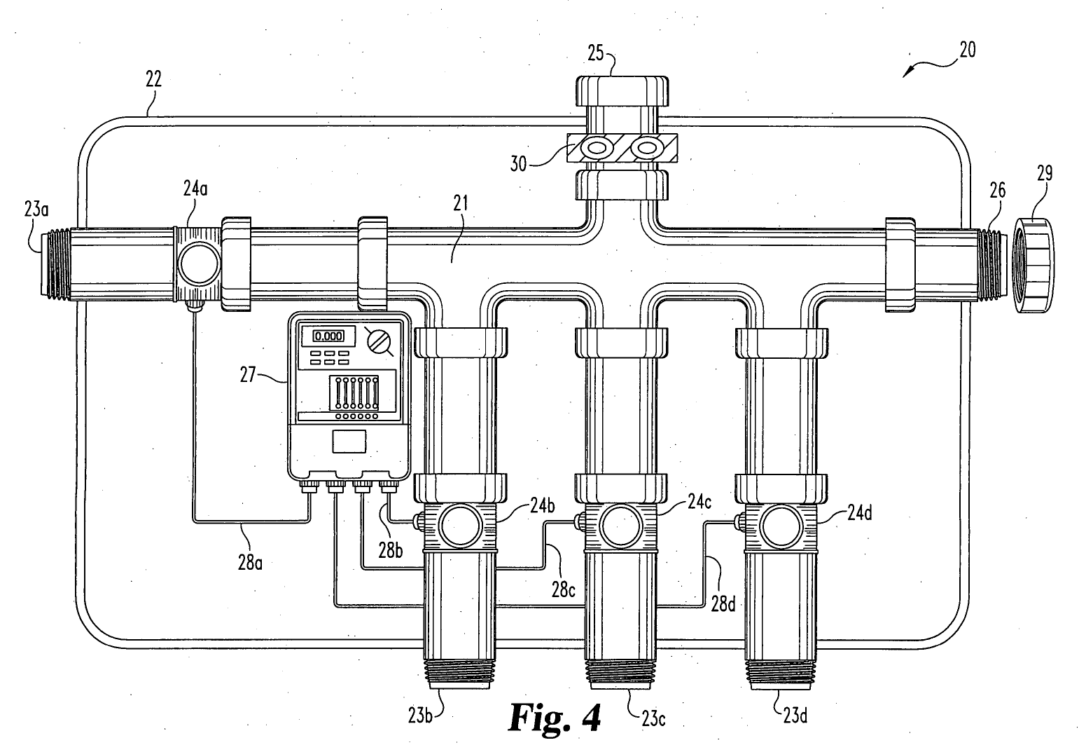

Referring now to FIG. 4, it will be understood that water inlet 25 has a standard female hose connector. It should be appreciated by one skilled in the art that standard hose connectors include both male and female threaded hose connectors for coupling a water hose to either a water inlet or outlet. The water inlet 25 is in constant forward fluid communication through backflow preventer valve 30 and manifold 21 with flow control valves 24 and water supply bypass outlet 26. Backflow preventer valve 30 is threadably connected to water supply inlet 25 and water manifold 21, and operates to prevent flow of water back into the water source. A backflow preventer of this type is disclosed in U.S. Pat. No. 3,171,423 which is incorporated in its entirety herein.

In the embodiment described, water supply bypass outlet 26 is in constant fluid communication with water supply inlet 25 to facilitate serial placement of units 20. Unit 20 includes a bypass outlet cap 29 for closing water supply bypass outlet 26 when unit 20 is to be used as the last unit in a serial arrangement. Alternatively, water supply bypass outlet 26 may have a non-electrically controlled valve such as a manual shutoff valve.

Preferably, four controlled outlets 23 are provided. A plurality of flow control valves 24 are connected adjacent to and in fluid communication with each of the controlled outlets 23. In the embodiment described a solenoid actuated flow control valve such as that manufactured by Orbit Irrigation Products, Inc. of North Salt Lake, Utah Series No. 62035 has proven satisfactory for valves 24a, 24b, 24c, and 24d.

Selective controller 27 is individually connected to flow control valves 24a, 24b, 24c, and 24d by control wires 28a, 28b, 28c, and 28d respectively. It will be understood that selective controller 27 is arranged to open flow control valves 24 in sequence so that water is supplied to the associated controlled outlets 23 at predetermined intervals for a desired period of time. When each flow control valve, for example 24a, is opened, water is supplied from the water supply inlet 25 through manifold 21 and flow control valve 24a to the associated controlled outlet 23a.

Selective controller 27 is operable to run one or more watering programs based upon the specific watering patterns programmed by the user. In the preferred embodiment, selective controller 27 includes a default program maintained in memory which opens each valve in the system sequentially for 20 minutes three times every day. Selective controller 27 also contains three watering start times or cycles. For example, cycle A may consist of watering each station for 30 minutes each day, while cycle B may include watering the first station for 90 minutes each day and the others for only 30 minutes. This program would be suitable for providing extra water to a garden or particularly dry area of the lawn.

In a further preferred embodiment, the selective controller 27 is battery powered to enable the system to provide watering functions in the absence of established power, which is often the case in new construction. In the illustrative embodiment, the selective controller manufactured by Orbit Irrigation Products, Inc. of North Salt Lake, Model No. 62032 has proven satisfactory for selective controller 27.

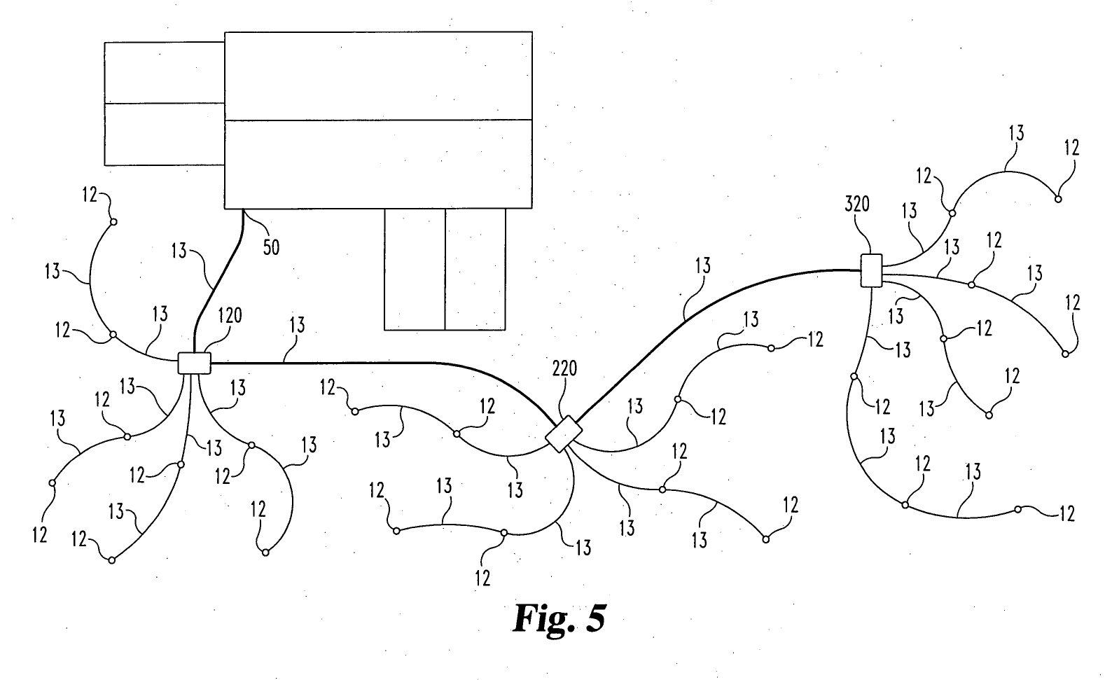

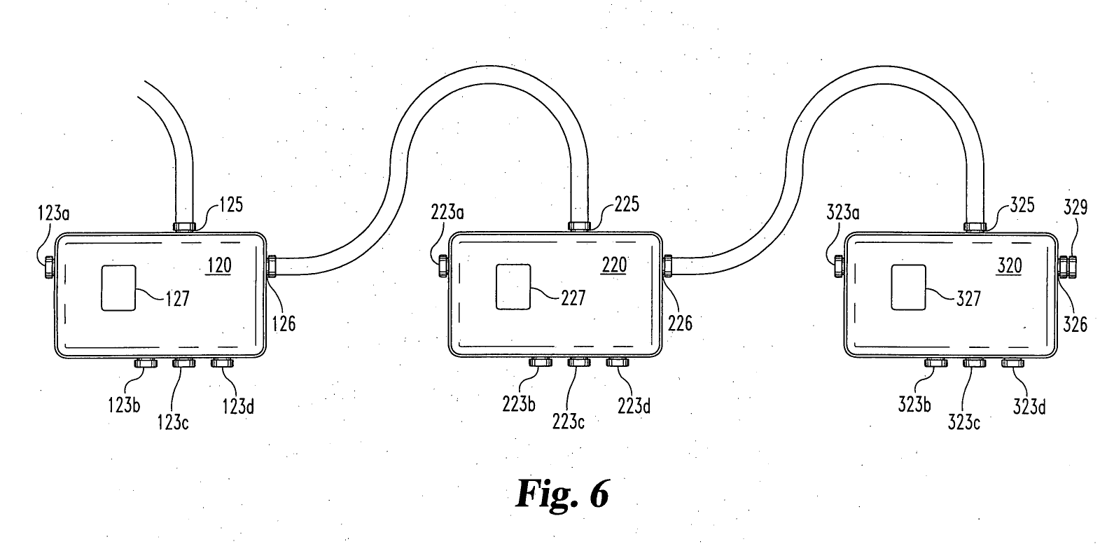

An important feature of sprinkling unit 20 is the capability to expand from a single water source to provide watering for areas of different sizes. Referring to FIG. 5-6, an expanded system includes two or more sprinkling units 20 serially connected, such as 120, 220, and 320. The system is capable of providing water to each unit 20 from a single water supply 50, such as a standard residential water bib. A standard water hose 13 is coupled to the water supply 50 at one end and to the water supply inlet 125 of the first unit 120 at the other. A second standard water hose 13 is then coupled to the water supply bypass outlet 126 of the first unit 120 at one end and to the water supply inlet 225 of the second unit 220. A third standard water hose 13 is then coupled to the water supply bypass outlet 226 of the second unit 220 at one end and to the water supply inlet 325 of the third unit 320. The third unit 320 then has cap 329 connected to water supply bypass outlet 326 as it is the last unit in the serial connection. The principles of this illustrative example can be easily extended to systems involving many more sprinkling units 20.

The user may then couple standard water hoses 13 to the various controlled outlets 23 of units 120, 220, and 320 in order to supply the various sprinkler heads 12 positioned about the lawn or garden. Additionally, the user may connect numerous sprinkler heads 12 to each outlet in a serial pattern. For a standard residential water outlet the typical flow rate is 8-10 gallons per minute, which is capable of supplying at least two sprinkler heads 13, each with a typical flow rate of 4 gallons per minute. Alternatively, the user may program the selective controller 27 to open two controlled outlets at once to operate two sprinklers 12 concurrently in the case where the sprinklers 13 are not serially connected.

In order to ensure proper pressure and flow to each sprinkler head 13 the user preferably programs the three selective controllers 127, 227, and 327 of each sprinkling units 120, 220, and 320 respectively to ensure that the water supply 50 is capable of providing adequate pressure and water flow. For example, the sprinkling system illustrated in FIG. 6 would be best utilized by programming each sprinkling unit 20 to operate exclusively. For instance, if the user desired a 15 minute watering from each controlled outlet 23 beginning at 1 pm, then the user would program sprinkling unit 127 to open controlled outlet 123a from 1:00-1:15, 123b from 1:15-1:30, 123c from 1:30-1:45, and 123d from 1:45-2:00. In a similar manner, selective controller 227 would then be programmed to open controlled outlet 223a from 2:00-2:15, 223b from 2:15-2:30, 223c from 2:30-2:45, and 223d from 2:45-3:00. Finally, selective controller 327 would then be programmed to open controlled outlet 323a from 3:00-3:15, 323b from 3:15-3:30, 323c from 3:30-3:45, and 323d from 3:45-4:00.

While the above example illustrates the principles of the invention, the characteristics of each watering application will vary. The watering needs of various lawns and climates will differ greatly. However, by utilizing the iterative programming strategy disclosed the user can create a program and system layout to satisfy those needs.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A sprinkler unit suitable for serial placement comprising:
a water supply inlet having a standard hose connector;
a supply bypass outlet having a standard hose connector, and free of electrically controlled valves whereby an unimpeded connection to a water supply inlet of another sprinkler unit can be achieved, either directly or through a standard hose;
two controlled outlets coupled to said water supply inlet through an associated flow control valve and having standard hose connectors;
a selective controller electrically connected to said flow control valves.

2. A sprinkler unit as defined in claim 1 having three controlled outlets coupled to said water supply inlet through an associated flow control valve and having standard hose connectors.

3. A sprinkler unit as defined in claim 1 having four controlled outlets coupled to said water supply inlet through an associated flow control valve and having standard hose connectors.

4. A sprinkler unit as defined in claim 1, wherein:
said flow control valves are solenoid actuated valves.

5. A sprinkler unit as defined in claim 1, wherein:
said supply bypass outlet is in constant fluid communication with said water supply inlet.

6. A sprinkler unit as defined in claim 1 which additionally includes a removable cap on said supply bypass outlet, whereby the unit can be used as the last unit of a series.

7. A sprinkler unit as defined in claim 1, wherein:
a housing encompasses said flow control valves.

8. A sprinkler unit as defined in claim 7 in which said standard hose connectors are adjacent to said housing.

9. A sprinkler unit as defined in claim 8 in which said standard hose connectors are outside said housing.

10. A sprinkler unit as defined in claim 7 in which said selective controller is coupled to said housing.

11. A sprinkler unit as defined in claim 7 in which said selective controller is within said housing.

12. A sprinkler unit as defined in claim 11 in which said selective controller is mounted to one of said flow control valves.

13. A sprinkler unit as defined in claim 1 wherein:
said standard hose connector associated with said water supply inlet is female.

14. A sprinkler unit as defined in claim 1 wherein:
said standard hose connectors associated with said controlled outlets are male.

15. A sprinkler unit as defined in claim 1 wherein:
said standard hose connector associated with said water supply bypass outlet is male.

16. A self contained battery operated sprinkler system comprising:
a water supply inlet having a standard hose connector;
two controlled outlets coupled to said water supply inlet through an associated flow control valve and having standard hose connectors;
a selective controller electrically connected to said flow control valves;
a battery connected to said selective controller to supply it power; and
a housing to which are mounted said flow control valves, selective controller, and battery.

17. A sprinkler unit as defined in claim 16 having three controlled outlets coupled to said water supply inlet through an associated flow control valve and having standard hose connectors.

18. A sprinkler unit as defined in claim 16 having four controlled outlets coupled to said water supply inlet through an associated flow control valve and having standard hose connectors.

19. A sprinkler unit as defined in claim 16, wherein:
said flow control valves are solenoid actuated valves.

20. A sprinkler unit as defined in claim 16, wherein:
a housing encompasses said flow control valves.

21. A sprinkler unit as defined in claim 20 in which said standard hose connectors are adjacent to said housing.

22. A sprinkler unit as defined in claim 21 in which said standard hose connectors are outside said housing.

23. A sprinkler unit as defined in claim 20 in which said selective controller is coupled to said housing.

24. A sprinkler unit as defined in claim 20 in which said selective controller is within said housing.

25. A sprinkler unit as defined in claim 24 in which said selective controller is mounted to one of said flow control valves.

26. A sprinkler unit as defined in claim 16 wherein:
said standard hose connector associated with said water supply inlet is female.

27. A sprinkler unit as defined in claim 16 wherein:
said standard hose connectors associated with said controlled outlets are male.

28. A sprinkler system capable of expansion from a single water supply comprising:
a plurality of water manifold structures, each water manifold structure comprising:
a water supply inlet having a standard hose connector;
three outlets each having a standard hose connector;
at least two of said outlets being controlled outlets coupled to said water supply inlet through an associated flow control valve and having standard hose connectors;
a water source;
a first inlet hose connected at one end to said water source and the other end connected to said first water manifold water supply inlet;
a second inlet hose connected at one end to one of said three outlets of said first water manifold and the other end connected to said second water manifold water supply inlet;
a selective controller electrically connected to said flow control valves of one of said water manifold structures and operable to open one of said first water manifold flow control valves; and
a selective controller electrically connected to said flow control valves of the other of said water manifold structures and operable to control said associated water manifold control valves.
